(19) United States
(12) Patent Application Publication
(10) Pub. No.: US 2015/0205811 A1
(43) Pub. Date: Jul. 23, 2015

(54) METHOD AND APPARATUS FOR OBTAINING CUSTOM EVENT AND TREND NOTIFICATIONS

(71) Applicant: Cisco Technology, Inc., San Jose, CA (US)

(72) Inventor: Robert Gregory Twiss, Chapel Hill, NC (US)

(73) Assignee: Cisco Technology, Inc., San Jose, CA (US)

(21) Appl. No.: 14/157,719

(22) Filed: Jan. 17, 2014

(51) Int. Cl. G06F 17/30

(52) U.S. Cl. CPC G06F 17/30106

(57) ABSTRACT

In one embodiment, a method includes obtaining, on a database system, a change definition request, the change definition request being obtained from a subscriber. The method also includes determining whether the change definition request defines a parametric change, the parametric change being associated with a parameter stored in the database system, and populating a criteria set associated with the parameter when it is determined that the change definition request is associated with the parametric change. Finally, the method includes determining when the parametric change occurs, and providing a first notification to the subscriber when it is determined that the parametric change has occurred.

### TECHNICAL FIELD

The disclosure relates generally to database systems such as data systems that contain complex, multi-variable data. More particularly, the disclosure relates to a platform which allows a user to flexibly create custom event and/or trend notifications based on attribute changes relating to data stored in a database.

### BACKGROUND

Many databases used by enterprises to track data contain complex, multi-variable data. Such databases may contain individual data records and associated documents. Complex, multi-variable data contained in a database may generally include elements that are characterized by at least one attribute or parameter. That is, each element or single component that is contained in a database may be substantially defined by a set of attributes that characterize the element. By way of example, a component such as a capacitor stored in a manufacturing parts database may be described by attributes that include, but are not limited to including, a capacitance, a dimensional size, a cost, a value tolerance, and/or a procurement risk rating.

Parametric data searches may be used to efficiently search a database that includes complex, multi-variable data. Parametric data searches allow for a searcher to specify multiple conditional parameters to refine searches performed on a database.

### BRIEF DESCRIPTION OF THE DRAWINGS

The disclosure will be readily understood by the following detailed description in conjunction with the accompanying drawings in which:

FIG. 1 is a diagrammatic representation of a process of requesting a notification relating to a particular attribute change and obtaining the notification when the particular attribute changes in accordance with an embodiment.

FIG. 2A is a diagrammatic representation of a process in which a subscriber that requests notification when a particular parameter changes in accordance with an embodiment.

FIG. 2B is a diagrammatic representation of a database system notifying a subscriber, e.g., database system 204 notifying subscriber 208 of FIG. 2A, of a change to a particular parameter after the subscriber requests notification relating to the particular parameter in accordance with an embodiment.

FIG. 2C is a diagrammatic representation of a database system notifying a subscriber, e.g., database system 204 notifying subscriber 208 of FIG. 2A, of a trend relating to a particular parameter after the subscriber requests notification with respect to the trend in accordance with an embodiment.

FIG. 3 is a diagrammatic representation of a process of maintaining change information in a database in accordance with an embodiment.

FIGS. 4A and 4B are a process flow diagram which illustrates a method of obtaining a notification relating to a change in a parameter, or a parametric data change, in accordance with an embodiment.

FIG. 5 is a process flow diagram which illustrates a method of providing a notification relating to a change in a parameter, or a parametric data change, in accordance with an embodiment.

FIG. 6 is a block diagram representation of a database system arranged to provide notifications relating to changes in parameters, or parametric data changes, in accordance with an embodiment.

FIG. 7 is a diagrammatic representation of a subscriber system requesting notification of changes to a parameter in accordance with an embodiment.

FIG. 8 is a diagrammatic representation of a change definition request, e.g., change definition request 752 of FIG. 7, in accordance with an embodiment.

FIG. 9 is a diagrammatic representation of a change definition request, e.g., change definition request 752 of FIG. 7, that specifies multiple parameters in accordance with an embodiment.

### DESCRIPTION OF EXAMPLE EMBODIMENTS

### General Overview

According to one aspect, a method includes obtaining, on a database system, a change definition request, the change definition request being obtained from a subscriber. The method also includes determining whether the change definition request defines a parametric change, the parametric change including at least one change associated with at least one parameter stored in the database system, and populating a criteria set associated with the at least one parameter when it is determined that the change definition request is associated with the parametric change. Finally, the method includes determining when the parametric change occurs, and providing a first notification to the subscriber when it is determined that the parametric change has occurred.

### Description

Using parametric data searches, or searches keyed on one or more parameters, to search databases that store complex, multi-variable data allows the databases to be efficiently, and relatively thoroughly, searched. A parametric data search generally allows a searcher to create and substantially focus a search based on at least one attribute or parameter of an entry or component stored in the database. To perform a parametric data search, a searcher may specify one or more conditional parameters to refine a search for a particular element associated with a database. Specifying conditional parameters also increases the precision associated with the search. For example, when searching a database that contains manufacturing parts, a searcher may search for a capacitor by searching for “every capacitor that has a 10 picoFarad (pF) value, a 10% tolerance, and a cost that is less than five cents.”

Contents of a database such as a database that stores complex, multi-variable data may be updated. While a searcher may periodically search the contents of a database to determine when data of interest to him or her, e.g., at least one particular attribute or parameter, has been updated or has otherwise changed, periodically searching the contents of the database may be inefficient. That is, performing repetitive searches in an effort to effectively catch a change in at least one attribute or a parameter may be inefficient.

By allowing a database system to substantially automatically notify a searcher or a party when at least one attribute or parameter associated with data stored in the database system has changed, the searcher or the party may efficiently obtain information relating to a change to the attribute or parameter. In one embodiment, a party may specify that he or she wishes to be notified by a database system when at least one particular attribute or parameter has changed, and when the database system determines when the particular attribute or parameter has changed, the database system may provide information relating to the changed attribute or parameter to the party. The party may substantially define the changes to attributes he or she would like to be notified about, and the database system may provide notification to the party as appropriate when the changes occur.

In general, a party may request notification when conditions pertaining to one or more attributes occur. Conditions, which may be specified in a change definition request, may have logical interrelationships. By way of example, conditions may be specified such that a notification is provided when one parameter changes and another parameter does not change, or when one parameter changes by a first amount and another parameter changes by a second amount. Conditions may also be specified such that a notification is provided when either a first parameter changes or a second parameter changes.

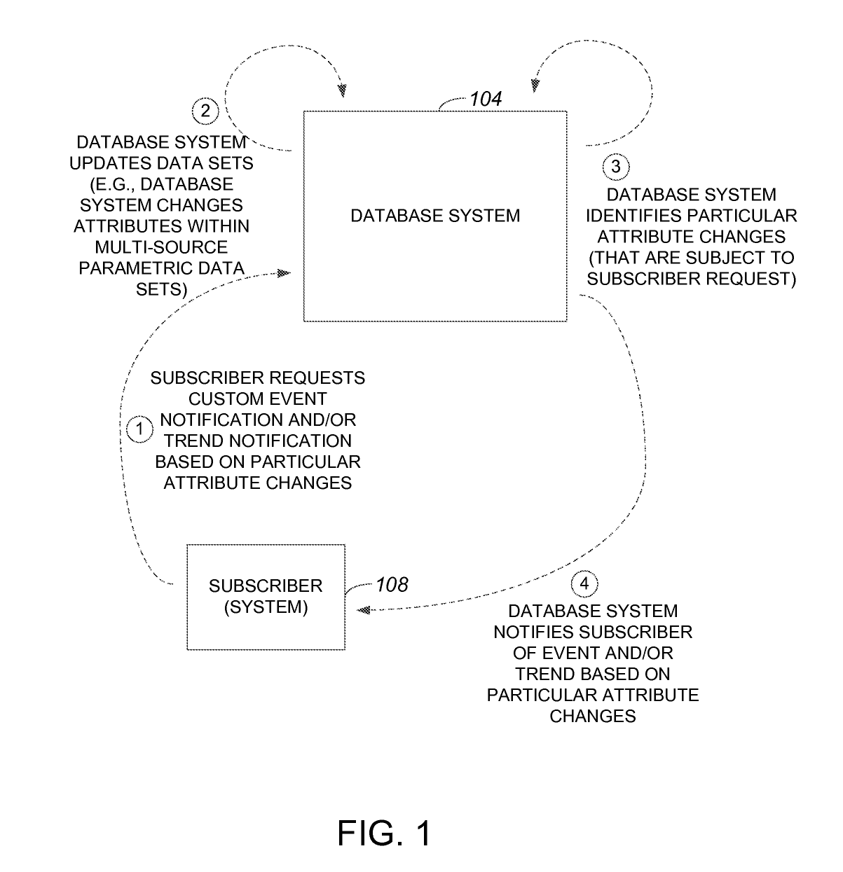

Referring initially to FIG. 1, a process of requesting a notification relating to a particular attribute change and obtaining the notification when the particular attribute changes will be described in accordance with an embodiment. A database system 104, which is arranged to store data, obtains a custom event notification and/or a trend notification request from a subscriber 108 at a time t1. In general, a subscriber 108 may be a party or an entity which requests notification from database system 104. Subscriber 108 may request that database system 104 notifies subscriber 108 when at least one particular attribute change is effectively detected within database system 104. Requesting an event notification may generally include requesting notification when an attribute changes, or when a set of attributes changes. Requesting a trend notification may generally include requesting notification relating to how one or more attributes, or values associated with the one or more attributes, change over time.

A custom event notification may generally be a definition provided by subscriber 108 which identifies at least one attribute or parameter, and a condition relating to the attribute or parameter. It should be appreciated that a custom event notification may effectively define one or more conditions to be met by one or more parameters or attributes, and is not limited to being a condition relating to a single attribute or parameter. Subscriber 108 may request notification when the condition occurs, and may also substantially specify a manner in which subscriber 108 is to be notified. Different manners in which database system 104 may notify subscriber 108 of attribute changes include, but are not limited to including, sending an e-mail, sending a text or short message service (SMS) message, creating or updating a file, and/or adding an entry to a database.

At a time t2, database system 104 updates data sets. For example, database system 104 may obtain inputs which cause data sets, or attributes associated with the data sets, to be updated. In one embodiment, database system 104 may change attributes within multi-source parametric data sets.

After updating data sets, database system 104 may identify particular attribute changes at time t3. The particular attribute changes may be attribute changes subscriber 108 requested notification for. Database system 104 may compare attributes as they were at time t1 to attributes as they were after data sets were updated at time t2, and identify whether attributes of interest to subscriber 108 have changed.

At a time t4, database system 104 notifies subscriber 108 of an event, e.g., a change in the attribute, or a trend associated with the attribute changes identified at time t3. As previously mentioned, database system 104 may notify subscriber 108 of an event or a trend using any suitable method.

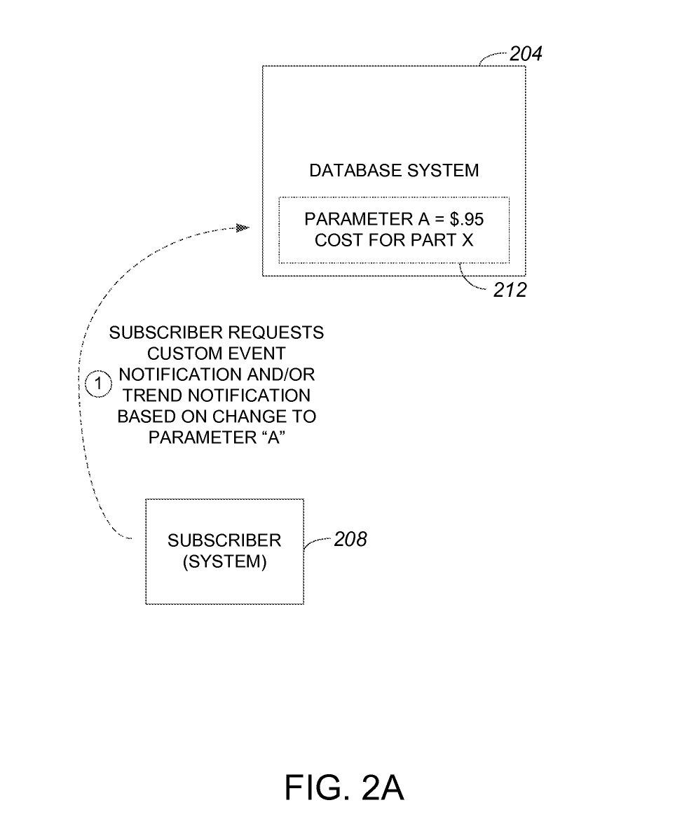

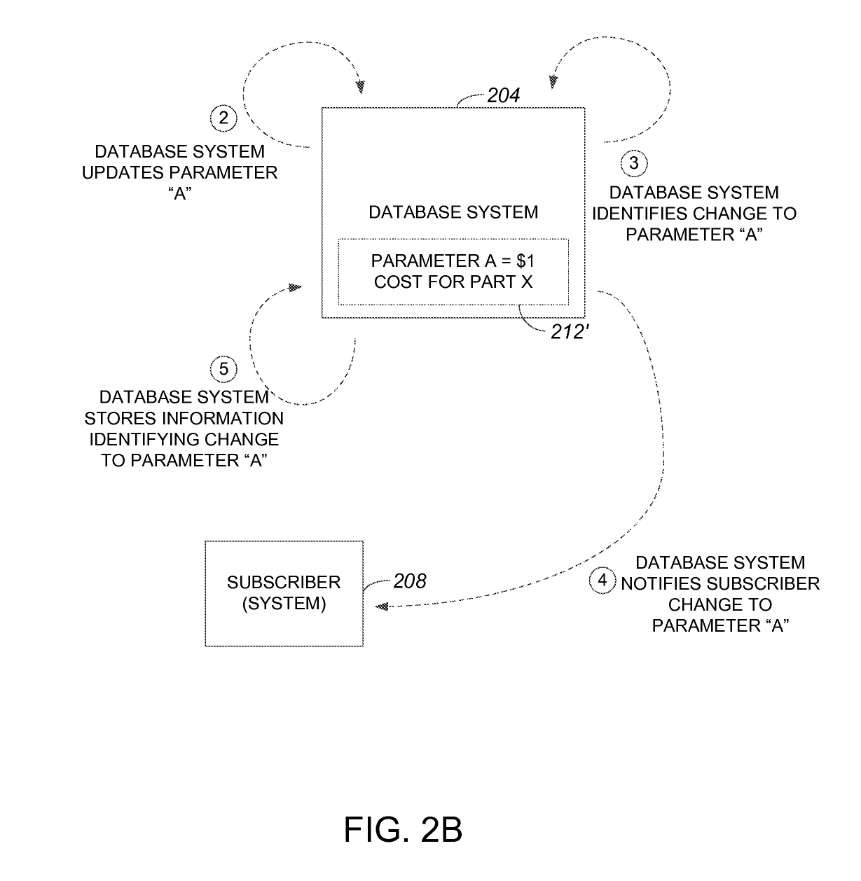

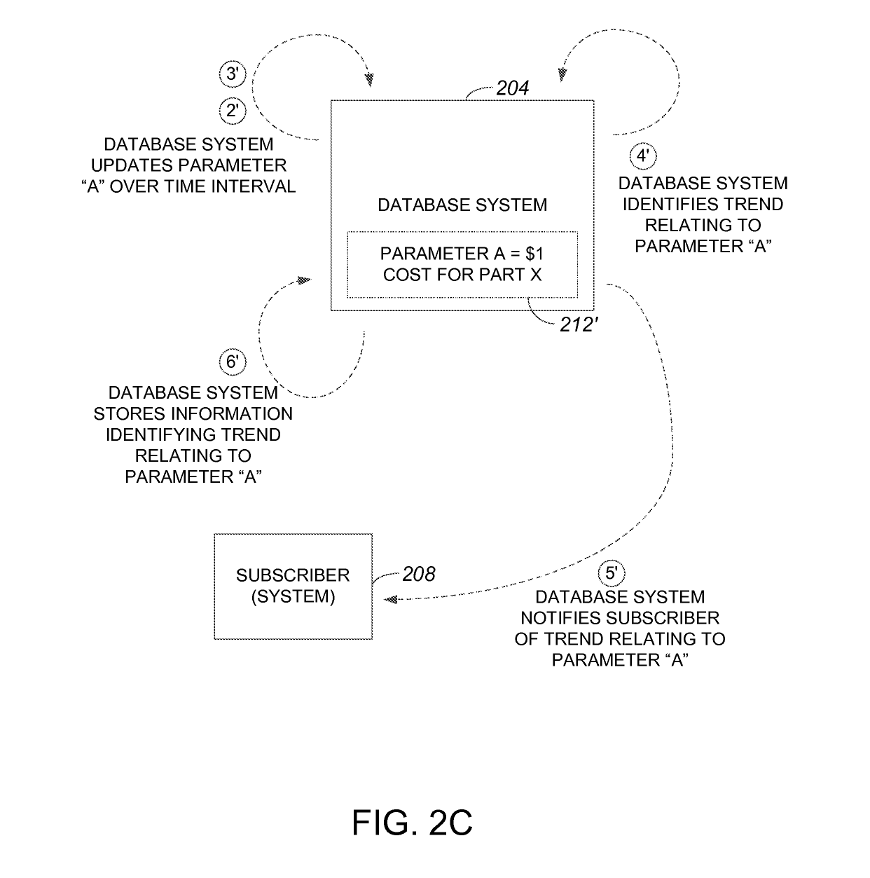

With reference to FIGS. 2A-2C, an example of requesting notification and providing notification when an attribute or parameter changes will be described in accordance with an embodiment. FIG. 2A is a diagrammatic representation of a process in which a subscriber that requests notification when a particular attribute or parameter changes in accordance with an embodiment. At a time t1 a subscriber 208 requests a notification with respect to a change definition. A change definition may be, for example a custom event notification and/or a trend notification associated with at least one parameter, e.g., parameter “A” 212. The request for a custom event notification and/or a trend notification may be provided to a database system 204. A request for a custom event notification, as mentioned above, generally is a request by subscriber 208 to be notified when a particular event occurs, e.g., when a change to a particular parameter occurs. A request for a trend notification may generally be a request by subscriber 208 to be notified of a trend relating to a particular parameter over a particular time period, or how a particular parameter changes over time. At time t1, parameter “A” 212, which is a cost for a part “X,” has a value of $0.95.

After subscriber 208 provides database system 204 with a request for a custom event notification and/or a trend notification, subscriber 208 may await notification. FIG. 2B is a diagrammatic representation of database system 204 notifying subscriber 208 of a change to a particular parameter after subscriber requests notification relating to the change to the particular parameter. At a time t2, database system 204 updates parameter “A” 212′. As shown, parameter ‘A’ 212′ is updated to have a value of $1.00. In general, database system 204 may update parameter “A” 212′ in response to an update request provided by a user (not shown) of database system 204.

Upon updating parameter “A” 212′, database system 204 effectively identifies that parameter “A” 212′ has changed, and that the change occurred at approximately time t2. Database system 204 identifies a change to parameter “A” 212′ at a time t3.

At a time t4, database system 204 notifies subscriber 208 of a change to parameter “A” 212′. Such a notification may be provided by database system 204 to subscriber 208 using any suitable method. Once the notification is provided, database system 204 may store information at a time t5 that identifies the change to parameter “A” 212′. The information that identifies the change to parameter “A” 212′ may be stored in a file (not shown) as an incremental change to parameter “A” 212′.

As previously mentioned, in lieu of subscriber 208 requesting a custom event notification, subscriber 208 may instead request a trend notification. The request for a trend notification may generally specify one or more parameters in which subscriber 208 is interested, and may also specify a time interval over which a trend related to the parameter is to be tracked. FIG. 2C is a diagrammatic representation of database system 204 notifying subscriber 208 of a trend with respect to a particular parameter after subscriber requests notification relating to the trend. From a time t2′ to a time t3′, database system 204 updates parameter “A” 212′. That is, during a time interval between time t2′ and time t3′, parameter “A” 212′ is updated. As shown, parameter ‘A’ 212′ may be updated to have a value of $1.00 by approximately time t3′.

Upon updating parameter “A” 212′ between time t2′ and time t3′, database system 204 effectively identifies a trend relating to parameter “A” 212′ at a time t4′. Such a trend may indicate how parameter “A” 212′ changed between time t2′ and time t3′.

At a time t5′, database system 204 notifies subscriber 208 of a trend relating to parameter “A” 212′. That is, database system 204 may send trend information relating to parameter “A” 212′. A notification that identifies a trend relating to parameter “A” 212′ may be provided by database system 204 to subscriber 208 using any suitable method. Once the notification is provided, database system 204 may store information at a time t6′ that identifies the trend relating to parameter “A” 212′. The information that identifies the trend relating to parameter “A” 212′ may be stored in a file (not shown) in database system 204.

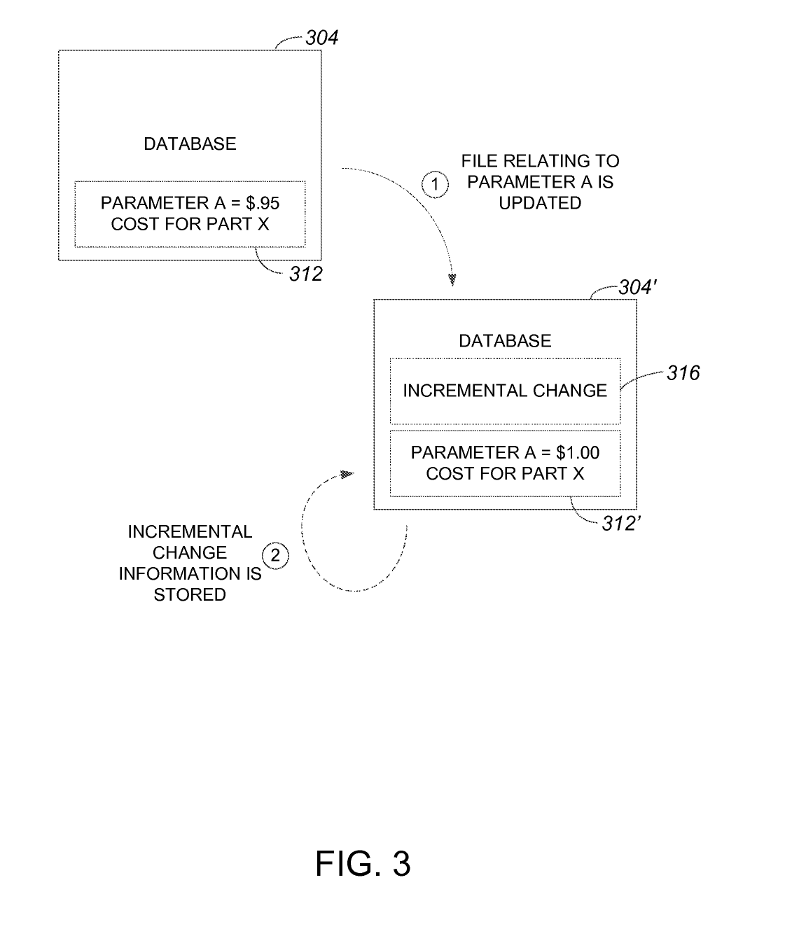

Change information, or information relating to changes in parameters, may be stored such that the change information is readily accessible. In one embodiment, change information may be stored in the same database that stores parameters. FIG. 3 is a diagrammatic representation of a process of maintaining change information in a database in accordance with an embodiment. A database 304 is generally configured to store complex, multi-variable data. In the described embodiment, database 304 stores both information about parameters and change information. As shown, database 304 initially includes parameter “A” 312. Parameter “A” 312 is a cost for a part “X,” and at an initial time t0, parameter “A” 312 has a particular value, e.g., a value of $0.95.

At a time t1, a file relating to parameter “A” 312 is updated. As a result of the update to the file relating to parameter “A” 312, database 304′ may also be updated. In the embodiment as shown, database 304′ is updated at time t1 such that the value of parameter “A” 312′ is changed. By way of example, parameter “A” 312′ may be changed to a value of $1.00. In addition to storing an updated value of parameter “A” 312′, incremental change information 316 may also be stored in database 304′. Incremental change information 316, which may be stored in database 304′ as an incremental change data set at a time t2, may be stored in a file which indicates that parameter “A” 312′ changed incrementally at time t1, e.g., from a value of $0.95 to a value of $1.00. Incremental change information 316 may also effectively indicate that parameter “A” 312′ was updated, or incrementally changed, at time t2. It should be appreciated that incremental change information 316 is not limited to being stored in database 304′. By way of example, incremental change information 316 may be stored in any suitable data structure, such as a data structure that is separate from database 304′.

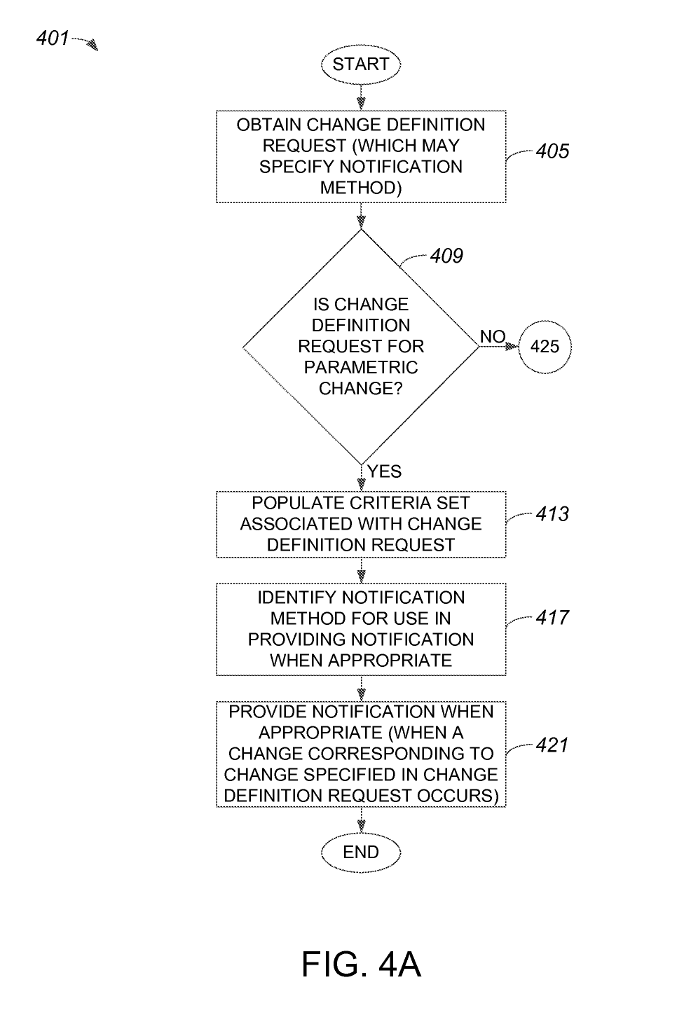

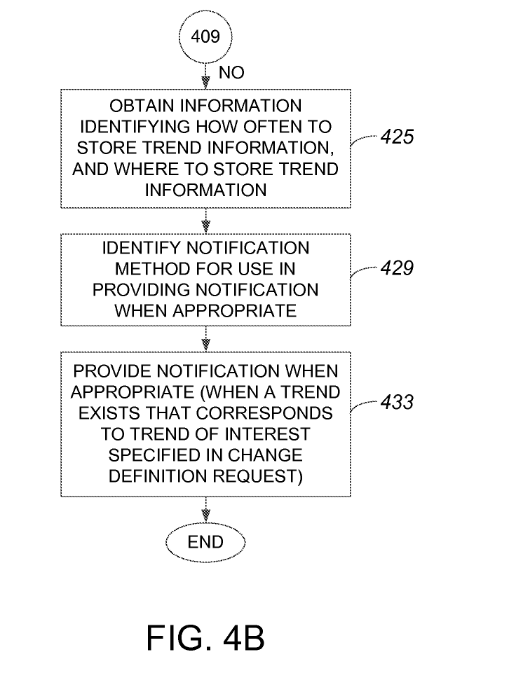

FIGS. 4A and 4B are a process flow diagram which illustrates a method of obtaining a notification relating to a change in one or more parameters, or a parametric data change, in accordance with an embodiment. A method 401 of obtaining a notification relating to a change in one or more parameters begins at step 405 in which a change definition request is obtained, e.g., by a database system. The change definition request may specify a notification method, or a method by which a user or subscriber wishes to be notified of changes in one or more parameters. For ease of discussion, changes to one parameter will be described, although it should be appreciated that a change definition request may generally specify a notification method by which a user or subscriber wishes to be notified of changes to more than one parameter and/or logical combinations of parameters. Typically, the change definition request may be obtained from the subscriber.

A determination is made in step 409 as to whether the change definition request is a change definition request for a parametric change. If the determination is that the change definition request is for a parametric change, then process flow moves to step 413 in which a criteria set associated with the change definition request is populated. Populating a criteria set may including setting at least one criterion which effectively specifies a condition which, if met with respect to a parameter, would trigger a notification. In other words, populating a criteria set may include setting at least one criterion which specifies a change that would trigger a notification.

Once a criteria set is populated, a notification method for use in providing a notification when appropriate is identified in step 417. In one embodiment, the notification method may be identified from the change definition request obtained in step 405. The notification is provided when appropriate in step 421. By way of example, a notification may be provided when a change corresponding to a change specified in a change definition request occurs. After the notification is provided when appropriate, the method of obtaining a notification is completed.

Returning to step 409, if it is determined that the change definition request does not specify or otherwise define a parametric change, the indication is that the change definition request is associated with trend information. The change definition request may be a request to obtain trend information which shows how at least one parameter, or at least one particular criterion, associated with a multi-source parametric data set changes over time. Accordingly, process flow moves from step 409 to step 425 in which information identifying how often to store trend information, and where to store trend information, is obtained. Such information may be obtained from, but is not limited to being obtained from, a change notification request.

In step 429, a notification method for use in providing a notification when appropriate is identified. The notification method may be identified, in one embodiment, from the change definition request obtained in step 405. The notification is provided when appropriate in step 433. It may be appropriate to provide a notification, for example, when a trend exists, or trend information exists, that corresponds to the trend of interest that was specified in a change definition request. Once the notification is provided when appropriate, the method of obtaining a notification is completed.

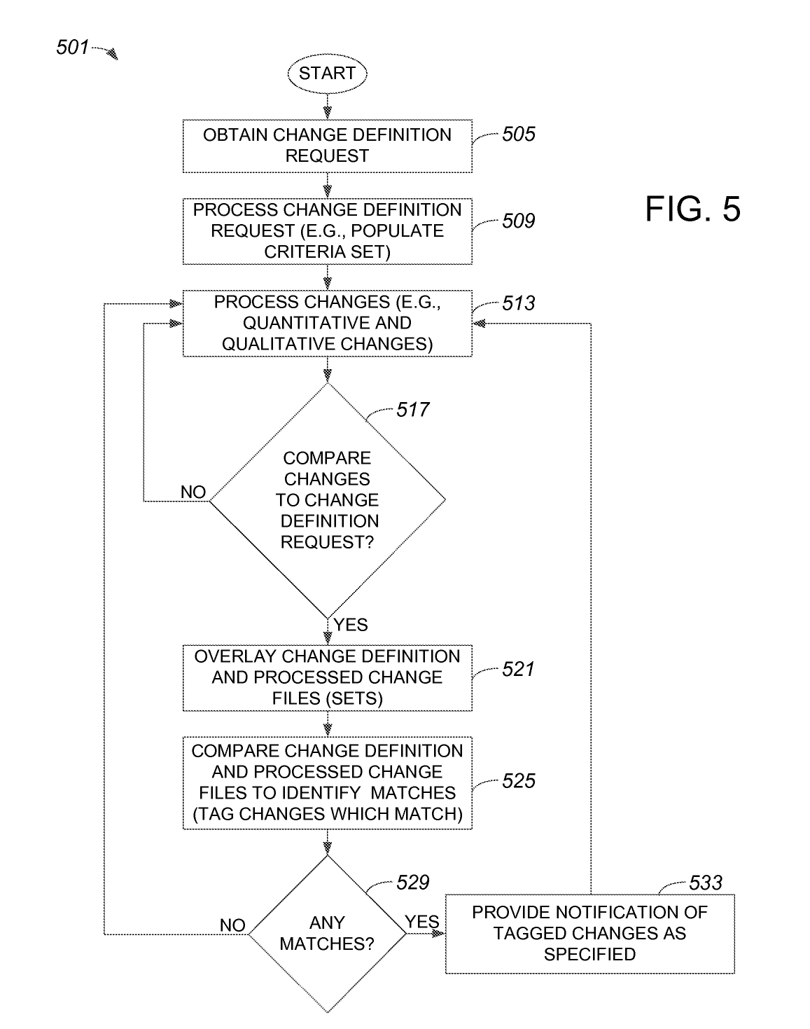

A database system to which a change definition request is directed may provide a notification when a change specified or otherwise defined in a change definition request has occurred. With reference to FIG. 5, a method of providing a notification relating to a change in a parameter, or a parametric data change, will be described from the point of view of a database system in accordance with an embodiment. A method 501 of providing a notification relating to a change in a parameter begins at step 505 in which a change definition request is obtained. Although providing a notification relating to a change in a parameter is described, it should be appreciated that a notification relating to changes in more than one parameter may be provided. Once the change definition request is obtained, the change definition request is processed in step 509. Processing the change definition request may include populating an associated criteria set. A criteria set may be associated with a change definition file. It should be appreciated that a criteria set may include one or more criterion.

In step 513, changes such as parametric data changes may be processed. That is, quantitative and qualitative changes in one or more parameters may be processed. It should be appreciated that processing changes may generally include obtaining updates pertaining to parameters stored in a database system. In one embodiment, when changes to a parameter are detected, a file, e.g., a processed change file, may be generated.

After changes are processed, a determination is made in step 517 as to whether the changes are to be compared to the change definition request. Comparing changes to a change definition request may occur periodically, at predetermined times, and/or when predetermined conditions are met. If the determination is that changes are not to be compared to a change definition request, process flow returns to step 513 in which changes are processed.

Alternatively, if the determination in step 517 is that changes are to be compared to a change definition request, the process flow moves from step 517 to page 521 in which a change definition file or set is effectively overlaid on a processed change file. Then, in step 525, a change definition file and a processed change file, or a file that contains parametric data changes, may be compared. A comparison of a change definition file and a processed change file may allow any matches to be identified and tagged. That is, changes which correspond to a change definition request are tagged. Hence, any parametric data changes which match a change definition request may be readily identified.

A determination is made in step 529 in which it is determined whether comparing a change definition file and a processed change file has resulted in any matches being found. If the determination is that no matches have been found, the indication is that it is not necessary to send a notification. As such, process flow returns to step 513 in which changes are processed.

Alternatively, if the determination in step 529 is that matches have been found in a comparison of a change definition file and a processed change file, the implication is that a notification is to be sent. Thus, in step 553, a notification relating to tagged changes may be provided as specified, e.g., as specified in a change definition request.

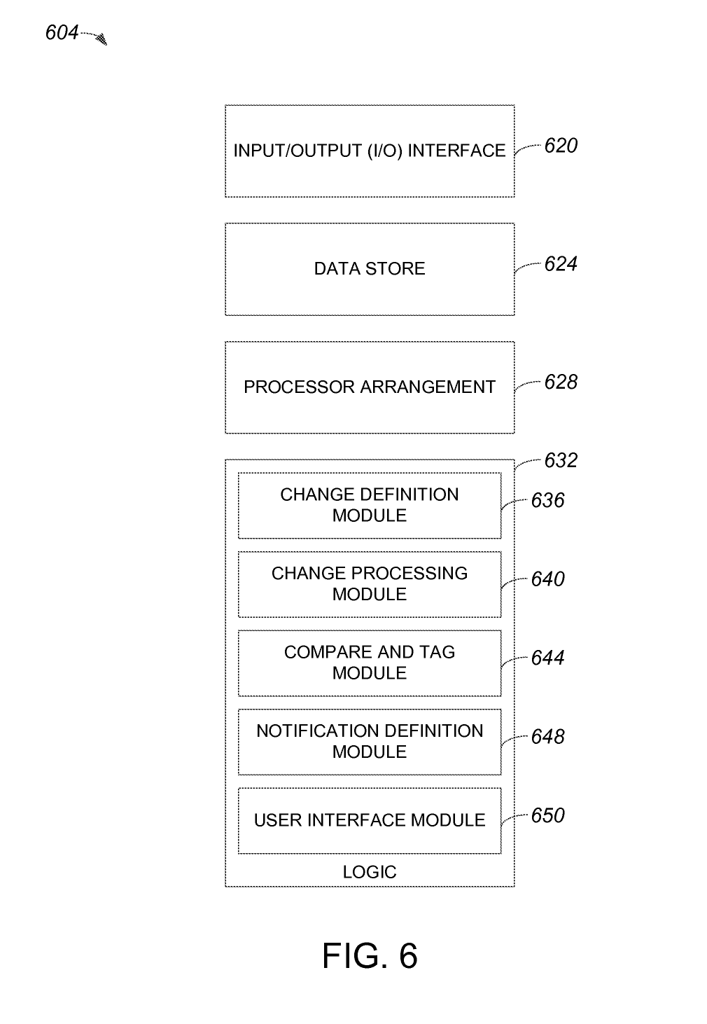

FIG. 6 is a block diagram representation of a database system arranged to provide notifications relating to changes in parameters, or parametric data changes, in accordance with an embodiment. A database system 604, which may be a server within a network, includes an input/output (I/O) interface 620, a data store 624, a processor arrangement 628, and logic 632. I/O interface 620, which may include at least one I/O port (not shown), allows database system 604 to obtain information from a network and to provide information to the network. Data store 624 is configured to store information, as for example parametric data such as parametric data associated with manufacturing parts. Processor arrangement 628 may include one or more processors (not shown).

Logic 632 may include hardware and/or software logic that is embodied on a computer-readable medium and arranged to be executed by processor arrangement 628. Logic 632 includes a change definition module 636, a change processing module 640, a compare and tag module 644, a notification definition module 648, and a user interface module 650.

Change definition module 636 is arranged to specify change notification criteria, as for example parametric change notification criteria obtained in a change notification request, and to populate and/or to update a criteria set. In general, change definition module 636 may specify one or more parameters, and information relating to changes associated with the one or more parameters which may effectively trigger a notification. Change definition module 636 may also create a change notification definition file associated with the change notification request.

Change processing module 640 allows changes, e.g., incremental changes made to parameters and/or data stored in data store 624, to be processed. Typically, change processing module 640 may process qualitative and quantitative data changes. It should be appreciated that data changes may generally be widely varied. By way of example, in addition to quantitative and qualitative or descriptive data changes, data changes may include, but are not limited to including, attribute changes relating to magnitude, attribute changes relating to direction and/or changes in the existence of data. In one embodiment, change processing module 640 may create and store a file, e.g., a processed change file, which identifies data changes relevant to particular parametric data.

Compare and tag module 644 is generally arranged to compare change notification definition files to processed change files to determine whether there are any matches. That is, compare and tag module 644 may determine if any parametric data changes correspond to change definitions specified in change definitions files. Compare and tag module 644 may effectively overlay change notification definition files and processed change files such that the files may be compared. When matches are found, i.e., when a change that is the subject of a requested change notification is found, the matches may be tagged or otherwise flagged.

Notification definition module 648 is arranged to notify a subscriber when a tagged change is associated with a change notification requested by the subscriber. Notification definition module 648 may notify a subscriber based on a specified notification, or communication method, and at a specified interval. In one embodiment, notification definition module 648 may include a cadence filter that processes a tagged change, and sends a notification relating to the tagged change.

User interface module 650 is generally arranged to allow a change definition to be obtained. In other words, user interface module 650 enables a user or a subscriber to submit a change definition request that may be processed by change definition module 636.

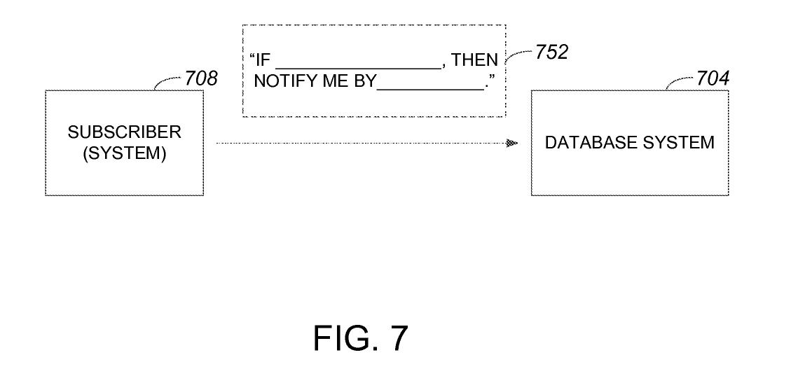

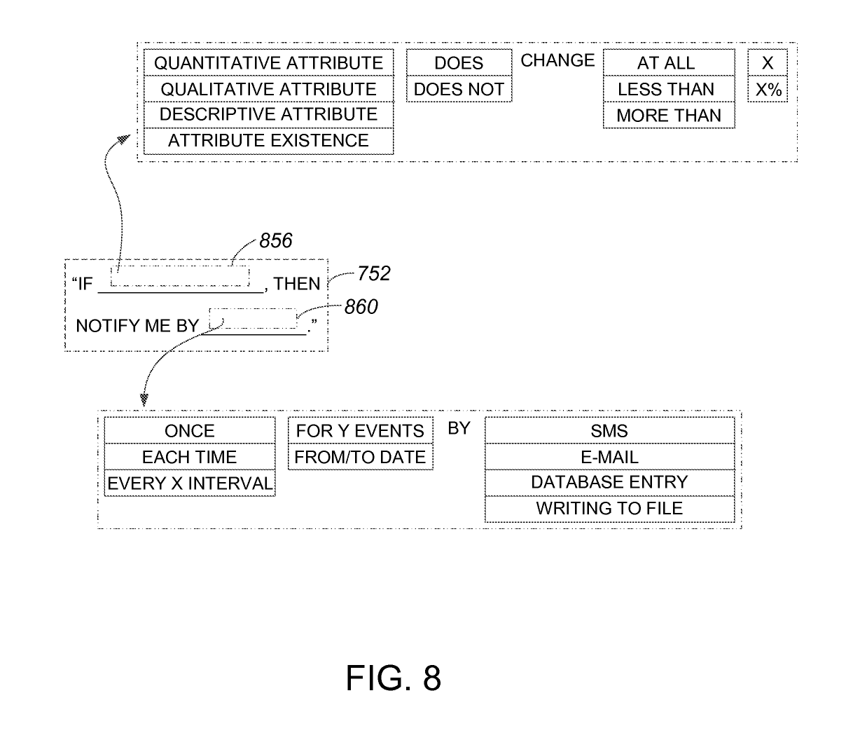

A change notification request may generally take any suitable form. By way of example, a change notification request may generally take the form of an “if-then statement” which specifies that if a particular condition occurs, then a notification relating to the particular condition is desired. An if-then statement may be a statement which indicates that if a particular condition occurs, then a notification is to be sent using a specified method. FIG. 7 is a diagrammatic representation of a subscriber system requesting notification of changes to a parameter in accordance with an embodiment. A subscriber system, 708, which may be a computer system operated by a party that requests a notification, is arranged to send a change notification request 752 to a database system 704. As will be described below with respect to FIG. 8, change notification request 752 may be arranged to specify a change definition, as well as a method to use to provide a notification when a suitable change is detected.

With reference to FIG. 8, one example of a change definition request, e.g., change definition request 752 of FIG. 7, will be described in accordance with an embodiment. Change definition request 752 includes a change definition specification 856, as well as a notification definition and delivery specification 860. Change definition specification 856 allows at least one attribute to be specified, and also effectively allows an amount by which the attribute is to change to be specified. It should be appreciated that the amount by which the attribute is to change may be specified as a new value for the attribute. Delivery specification 860 allows a method for delivery of a notification to be specified, and may also allow a number of notifications, as well as a time at which a notification is to be sent, to be specified.

Change definition specification 856 allows an attribute such as a quantitative attribute, a qualitative attribute, and/or a descriptive attribute to be specified. An existence of an attribute, e.g., whether an attribute is present or not present in a database system, may be specified in lieu of specifying an attribute. In other words, change definition specification 856 allows a quantitative change, a qualitative change, a descriptive change, and/or a change in existence for a parameter or an attribute to be specified.

Change definition specification 856 also allows a specification of how much an attribute or parameter is to change, or how much an attribute or parameter is not to change, before a notification is to be provided. For example, change definition specification 856 may specify a condition that triggers a notification when a previously existing attribute is no longer in existence, or vice versa.

Delivery specification 860 may specify how often a notification is to be sent when a particular condition occurs, as well as how to send or to otherwise provide the notification. By way of example, delivery specification 860 may specify that a notification is to be sent each time a condition occurs within a particular time frame, and may also specify whether such a notification is to be sent in an SMS message, sent in an e-mail message, provided as a database entry, or provided in a file.

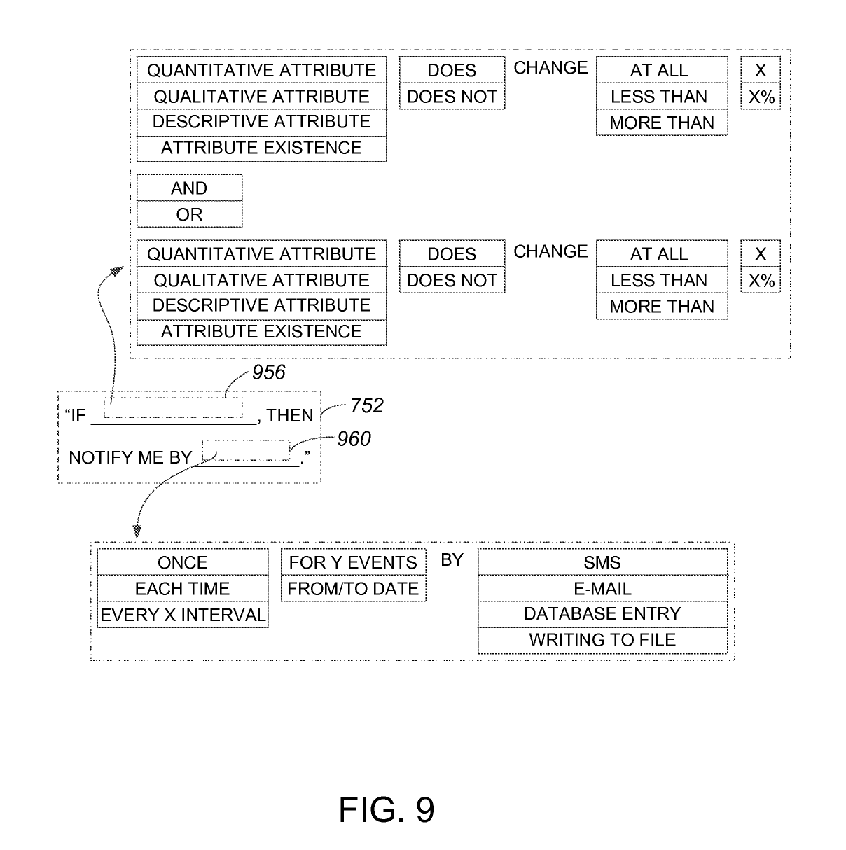

A change definition request may specify one or more attributes which are to change, or not to change, before a notification is provided. By way of example, a change definition request may specify that a notification is to be sent if a first condition and a second condition occur. Alternatively, a change definition request may specify that a notification is to be sent if a first condition occurs but a second condition does not occur. Referring next to FIG. 9, one example of a change definition request, e.g., change definition request 752 of FIG. 7, which specifies more than one attribute will be described in accordance with an embodiment. Change definition request 752 includes a change definition specification 956, as well as a notification definition and delivery specification 960.

Change definition specification 956 allows two or more attributes to be specified, with a logical construct, and also effectively allows an amount by which the attributes are to change to be specified. It should be understood that while two attributes are shown for ease of illustration, more than two attributes may be specified in change definition specification 956, and the attributes may be substantially separated by a logical operator. Logical operators may include, but are not limited to including, “and,” “or,” and “and not.” Change definition specification 956 allows a specification of two or more conditions which are to occur prior to a notification being sent. Change definition specification 956 allows attributes such as quantitative attributes, qualitative attributes, and descriptive attributes to be specified. Change definition specification 956 also allows a specification of how much each attribute is to change, or how much each attribute is not to change, before a notification is to be provided.

Delivery specification 960 allows a method for delivery of a notification to be specified, and may also allow a number of notifications, as well as a time at which a notification is to be sent, to be specified. Delivery specification 960 may specify how often a notification is to be sent when a particular condition occurs, as well as how to send or to otherwise provide the notification.

Although only a few embodiments have been described in this disclosure, it should be understood that the disclosure may be embodied in many other specific forms without departing from the spirit or the scope of the present disclosure. By way of example, the ability to request, provide, and/or obtain a notification relating to changes in a parameter has generally been described as implemented with respect to databases that contain complex, multi-variable data such as parametric parts databases. Functionality which allows notifications relating to changes in a parameter to be requested, provided, and/or obtained is not limited to being implemented with respect to database that complain complex, multi-variable data. Such functionality may generally be implemented with respect to any suitable data set or database application.

A database system has generally been described as being a component, e.g., a server, within a network. It should be appreciated, however, that a database system is not limited to being a substantially single component in a network. In one embodiment, a database system may be distributed such that functionality associated with a database system is effectively implemented on multiple components within a network.

In one embodiment, notifications that are requested by a user may be considered to be notification subscriptions. Such notification subscriptions may be shared among multiple parties with access to information stored in database. A creator of a notification subscription may allow other parties to subscribe to the notification subscription such that the other parties are notified when at least one parameter of interest has changed. For example, a creator of a notification subscription may name the notification subscription in order to facilitate sharing the notification subscription. In general, a creator of a notification subscription may specify that substantially only the creator may subscribe to the notification subscription, that other parties may subscribe to the notification subscription, and/or that other parties may modify the notification subscription.

The embodiments may be implemented as hardware, firmware, and/or software logic embodied in a tangible, i.e., non-transitory, medium that, when executed, is operable to perform the various methods and processes described above. That is, the logic may be embodied as physical arrangements, modules, or components. A tangible medium may be substantially any computer-readable medium that is capable of storing logic or computer program code which may be executed, e.g., by a processor or an overall computing system, to perform methods and functions associated with the embodiments. Such computer-readable mediums may include, but are not limited to including, physical storage and/or memory devices. Executable logic may include, but is not limited to including, code devices, computer program code, and/or executable computer commands or instructions.

It should be appreciated that a computer-readable medium, or a machine-readable medium, may include transitory embodiments and/or non-transitory embodiments, e.g., signals or signals embodied in carrier waves. That is, a computer-readable medium may be associated with non-transitory tangible media and transitory propagating signals.

The steps associated with the methods of the present disclosure may vary widely. Steps may be added, removed, altered, combined, and reordered without departing from the spirit of the scope of the present disclosure. Therefore, the present examples are to be considered as illustrative and not restrictive, and the examples is not to be limited to the details given herein, but may be modified within the scope of the appended claims.

What is claimed is:

1. A method comprising:
obtaining, on a database system, a change definition request, the change definition request being obtained from a subscriber;
determining whether the change definition request defines a parametric change, the parametric change including at least one change associated with at least one parameter stored in the database system;
populating a criteria set associated with the at least one parameter when it is determined that the change definition request is associated with the parametric change;
determining when the parametric change occurs; and
providing a first notification to the subscriber when it is determined that the parametric change has occurred.

2. The method of claim 1 wherein the change definition request specifies a notification method for providing the first notification.

3. The method of claim 1 wherein when it is determined that the change definition request is not associated with the parametric change, the change definition request is associated with a trend notification request, the trend notification request being associated with trend information associated with the at least one parameter.

4. The method of claim 3 wherein when it is determined that the change definition request is not associated with the parametric change, the method further includes:
obtaining information identifying how to store the trend information;
determining when to provide the trend information to the subscriber; and
providing a second notification to the subscriber when it is determined that the trend information is to be provided to the subscriber.

5. The method of claim 4 wherein determining when to provide the trend information to the subscriber includes determining when the trend information corresponds to a trend of interest, the trend of interest being specified in the trend notification request.

6. The method of claim 1 further including:
creating a processed change file, the processed change file being arranged to contain information associated with the parametric change, wherein determining when the parametric change occurs includes comparing the processed change file to the change definition request.

7. The method of claim 1 wherein the parametric change includes one selected from a group including a quantitative change, a qualitative change, a descriptive change, and a change in existence.

8. A tangible, non-transitory computer-readable medium comprising computer program code, the computer program code, when executed, configured to:
obtain a change definition request, the change definition request being obtained from a subscriber;
determine whether the change definition request defines a parametric change, the parametric change including at least one change associated with at least one parameter stored in a database system;
populate a criteria set associated with the at least one parameter when it is determined that the change definition request is associated with the parametric change;
determine when the parametric change occurs; and
provide a first notification to the subscriber when it is determined that the parametric change has occurred.

9. The tangible, non-transitory computer-readable medium comprising computer program code of claim 8 wherein the change definition request specifies a notification method for providing the first notification.

10. The tangible, non-transitory computer-readable medium comprising computer program code of claim 8 wherein when it is determined that the change definition request is not associated with the parametric change, the change definition request is associated with a trend notification request, the trend notification request being associated with trend information associated with the at least one parameter.

11. The tangible, non-transitory computer-readable medium comprising computer program code of claim 10 wherein when it is determined that the change definition request is not associated with the parametric change, the computer program code is further configured to:
obtain information identifying how to store the trend information;
determine when to provide the trend information to the subscriber; and
provide a second notification to the subscriber when it is determined that the that the trend information is to be provided to the subscriber.

12. The tangible, non-transitory computer-readable medium comprising computer program code of claim 11 wherein the computer program code configured to determine when to provide the trend information to the subscriber is further configured to determine when the trend information corresponds to a trend of interest, the trend of interest being specified in the trend notification request.

13. The tangible, non-transitory computer-readable medium comprising computer program code of claim 8 wherein the computer program code is further configured to:
create a processed change file, the processed change file being arranged to contain information associated with the parametric change, wherein the computer program code configured to determine when the parametric change occurs is further configured to compare the processed change file to the change definition request.

14. The tangible, non-transitory computer-readable medium comprising computer program code of claim 8 wherein the parametric change includes one selected from a group including a quantitative change, a qualitative change, a descriptive change, and a change in existence.

15. An apparatus comprising:
a processor;
a database; and
a logic module, the logic module being configured to cooperate with the processor to obtain a change definition request from a subscriber, to determine whether the change definition request defines a parametric change associated with at least one parameter arranged to be stored in the database, to determine when the parametric change occurs when it is determined that the change definition request defines the parametric change, and to provide a first notification to the subscriber when it is determined that the parametric change has occurred.

16. The apparatus of claim 15 wherein when it is determined that the change definition request is not associated with the parametric change, the change definition request is associated with a trend notification request, and the logic module is further configured to cooperate with the processor to obtain information identifying how to store the trend information, to determine when to provide the trend information to the subscriber, and to provide a second notification to the subscriber when it is determined that the trend information is to be provided to the subscriber.

17. The apparatus of claim 16 wherein the logic module is configured to determine when to provide the trend information to the subscriber is further configured to determine when the trend information corresponds to a trend of interest, the trend of interest being specified in the trend notification request.

18. The apparatus of claim 15 wherein the logic module is further configured to cooperate with the processor to create a processed change file, the processed change file being arranged to contain information associated with the parametric change, and wherein the logic module is still further configured to determine when the parametric change occurs by comparing the processed change file to the change definition request.

19. The apparatus of claim 15 wherein the parametric change is one selected from a group including a quantitative change, a qualitative change, a descriptive change, and a change in existence.

20. The apparatus of claim 15 wherein the change definition request specifies a notification method for providing the first notification.
